(19) United States
(12) Patent Application Publication
(10) Pub. No.: US 2012/0312247 A1
(43) Pub. Date: Dec. 13, 2012

(54) Canine-Actuated Devices and Systems

(76) Inventor: Russell Ebersole, Stephenson, VA (US)

(21) Appl. No.: 13/316,541

(22) Filed: Dec. 11, 2011

Related U.S. Application Data
(60) Provisional application No. 61/422,638, filed on Dec. 13, 2010.

(51) Int. Cl. A01K 15/02; G08B 23/00

(52) U.S. Cl. 119/712; 340/573.3

(57) ABSTRACT

Devices and systems are disclosed which are specially adapted to enable trained animals, particularly canines, to actuate electrical and electronic circuits in order to control various mechanical, electronic, and electrical equipment on behalf of one or more humans. At least one embodiment of the present invention comprises a bezel-protected contact plate connected to a household electrical circuit enabling canines weighing between 5 to 250 pounds to transmit emergency alert signals to first responders, to operate lights and household appliances, and to perform any other similar functions. The bezel-protected contact plate is mounted in a stationary control box containing internal electric components to modulate the output of the signal resulting from the animal's actuation of said plate. The present invention permits canines to assist humans in generating appropriate responses to emergency conditions or commands.

### CROSS REFERENCE TO RELATED APPLICATIONS

This application claims the benefit of U.S. Provisional Application No. 61/422,638 filed on Dec. 13, 2010.

### BACKGROUND OF THE INVENTION

1. Field of the Invention

The present invention relates to animal-actuated devices and systems, and more particularly to canine-actuated devices and systems for providing or summoning assistance to a person or a location by virtue of operating electrical, electronic, signaling, or emergency alert devices and systems.

2. Description of the Related Art

No admission is made that any reference, including any patent or patent document, cited in this specification constitutes prior art applicable to the present invention. Applicant reserves the right to challenge the accuracy and pertinence of any of the documents cited herein. The following review of related art is intended to provide edifying examples of problems and pitfalls in the design and use of animal actuated devices and systems. The discussion of the references states what their authors assert, and the applicant reserves the right to challenge the accuracy and pertinency of any of the documents cited herein.

Animals can be trained to reliably perform specific tasks in response to cues, which can be either specific or generalized cues. Animals can also learn from their experiences, and learning can be modulated by trainers who provide positive and negative feedback in response to an animal's behaviors. Learning is distinguished from training in that learning is a relatively permanent change in behavior resulting from sensory experience, while training is the result of conditioning through forced repetition. However, for the purposes of this disclosure, learning and training are interchangeable terms.

Dogs, i.e., members of the genus, Canis, particularly varieties of the species Canis lupus, are considered highly trainable. The various breeds of domesticated dogs, Canis lupis familiaris, have idiosyncratic advantages and disadvantages depending on intelligence, sensory acuity, and inherent obedience, but all can be trained to perform complex tasks and/or logical calculations. Historically, dogs have been trained for purposes ranging from hunting, fighting, and guarding to more modern activities like bomb and narcotics detection, leading of the deaf and blind, search and rescue operations, and the physical protection of other animals or people.

Systems and devices actuated by animals can be conceptually separated into two families: those triggered unintentionally by the animal (the passive family), and those triggered intentionally by the animal (the active family). The passive family generally comprises those systems and devices that are actuated by the animal indirectly, unwittingly, or non-volitionally. Inventions that belong in the passive family typically include pet collars incorporating interactive elements (i.e., RFID tags, magnets), electric shock collars, hidden switches placed in pillows and mats, and the like. For example, see U.S. Pat. No. 1,118,283 to Holdehofer (“Carrier Pigeon Signal,” issued Nov. 24, 1914); U.S. Pat. No. 4,216,743 to Cohen (“Magnetically Unlocked Pet Door,” issued Aug. 12, 1980); U.S. Pat. No. 4,551,713 to Aossey (“Pet Doormat Alarm,” issued Nov. 5, 1985); and, U.S. Pat. No. 5,067,441 to Weinstein (“Electronic Assembly for Restricting Animals to Defined Areas,” issued Nov. 26, 1991); U.S. Pat. No. 5,705,990 to Messier (“Multiple Switch Pad,” issued Jan. 6, 1998). Although an animal may learn to actively use such inventions through associative learning after it observes the predictability of some response to a given behavior, like when swine learn that stepping on the platform in front of a feeding trough coincides with food being deposited in the trough, inventions in the passive family do not require such learning by the animal in order to operate as intended; i.e., the swine have no choice but to step on the platform in front of their feeding trough when eating. For further example, a cat wearing an RFID collar that activates the opening of a pet door to its master's house does not consciously or volitionally trigger the device when the cat approaches said pet door, but rather the actuation happens automatically by virtue of the RFID system. Similarly, the typical dog does not deliberately seek a shock from its collar when it violates the bounds of a perimeter system.

The present invention describes animal actuated devices and systems which belong to the active family of animal-actuated inventions. The active family comprises those inventions in which the animal is trained to volitionally actuate a system or device in response to a specific or general cue. The functionality and utility of such inventions may require prior training of the animal, including the development within the animal of the ability to recognize a designated cue, the reliable tendency to respond to said cue with an act or behavior directed towards the invention, and the capacity to successfully interact with an actuating element of the system such that there is a very high probability that actuation is achieved. The animal need not comprehend the significance of its act in response to a cue, nor need it be aware of any or all of the act's consequences.

A first and relatively simplistic genus of inventions in the active family of animal-actuated inventions includes automatic feeders and waterers, some of which may also be classifiable in the passive family if the animal has not yet learned that its behavior is causing a response. See, for example, U.S. Pat. No. 1,064,540 to Regar (“Sanitary drinking fountain for horses and cattle,” issued Jun. 10, 1913); U.S. Pat. No. 3,044,446 to Vanderhoven (“Drinking Trough for Animals,” issued Jul. 17, 1962); U.S. Pat. No. 3,272,181 to Ramsey (“Animal Actuated Drinking Fountain,” issued Sep. 16 1966); U.S. Pat. No. 4,729,414 to Beber (“Animal Water Dispensing Device, issued Mar. 8, 1988); U.S. Pat. No. 4,924,812 to Bernays, Jr. (”Water Bowl Fountain,” issued May 15, 1990); U.S. Pat. No. 5,613,464 to Petzel (“Platform Actuated Feeder Apparatus,” issued Mar. 25, 1997); U.S. Pat. No. 5,709,169 to Ryles (“Animal Feeding Apparatus,” issued Jan. 20, 1998); U.S. Pat. No. 6,279,508 B1 to Marchant et al. (“Pet watering fountain,” issued Aug. 28, 2001); U.S. Pat. No. 6,446,574 B2 to Bickley (“Animal Actuated Feeder,” issued Sep. 10, 2002); U.S. Pat. No. 6,526,916 B1 to Perslweig (“Pet Fountain,” issued Mar. 4, 2003); and, U.S. Pat. No. 7,469,657 to Drummond (“Apparatus and Method for Controlling an Animal's Access to Food,” issued Dec. 30, 2008). These devices are actuated by the animal after it is trained or has learned through experience that depressing a lever or platform on a device yields food or water from the device. The animal will use the invention by intentionally depressing the lever or platform element until either its hunger or the cache of food or water is extinguished. The animal intends to activate the system or device and the appropriate goal of the invention (i.e., successful feeding) is achieved downstream of the animal's act.

A second genus of active animal-actuated inventions comprises apparatuses which enable an animal to communicate a desire to its owner, such as a desire to be let through a door or a desire to play with a toy. These inventions enable a pet to interact with its owner, but do not enable a pet to communicate information about its owner, or to act on behalf of its owner. U.S. Pat. No. 4,400,696 to Klingensmith (“Animal-actuated Attention Attracting Apparatus,” issued Aug. 23, 1983) describes a hinged panel for mounting on a door that when depressed by an animal transmits a signal to a bell or other sounding means, from which the owner may deduce that the animal desires passage through said door. U.S. Pat. No. 4,414,921 to Cozzi (“Training Aid Bell for Pets,” issued Nov. 15, 1983) performs essentially identically to the Klingensmith apparatus but allows the animal to communicate an expanded range of present desires to its owner. The majority of inventions in this genus relate to animal-actuated doorbells. See, for example, U.S. Pat. No. 4,323,883 to Sowards (“Doorbell for Pets,” issued Apr. 6, 1982) and U.S. Pat. No. 4,686,504 to German (“Pet Operable Annunciator,” issued Aug. 11, 1987) which claim lever-operated switches mounted adjacent to a door; U.S. Pat. No. 4,908,484 to Gunoff (“Doorbell Activating Device for Pets,” issued Mar. 13, 1990) claiming a pull means that activates a doorbell when grasped and pulled vertically downwards by a pet; U.S. Pat. No. 5,303,677 to Jones (“Pet Entrance Pager,” issued Apr. 9, 1994) describing a self-contained buzzer system mountable on a door; U.S. Pat. No. 5,475,369 to Baker (“Animal Actuating Signaling Device,” issued Dec. 12, 1995), U.S. Pat. No. 5,604,478 to Grady (“Pet-Operable Door Chime,” issued Feb. 18, 1997), U.S. Pat. No. 5,952,926 to Syverson (“Pet Doorbell Apparatus,” issued Sep. 14, 1999), U.S. Pat. No. 6,094,139 to Moore (“Door Bell for Pets,” issued Jul. 25, 2000), U.S. Pat. No. 6,433,692 to Kenum (“Animal Actuated Signaling Device,” issued Aug. 13, 2002), U.S. Pat. No. 6,445,302 B2 to Vena (“Pet Wireless Doorbell Device,” issued Sep. 3, 2002) which claim pet-actuated levers that communicate wirelessly to sound-generating elements; and U.S. Pat. No. 6,240,880 B1 to Jones (“Training Device for Pets,” issued Jun. 5, 2001) comprising an actuating lever and a buzzer mounted on a single floor-standing unit. In all of the examples, the animal actuates the signaling apparatus to communicate its own needs or desires to a human caretaker, but the animal does not actuate these devices to perform acts on behalf of its owner or a third party.

Slightly more sophisticated inventions in this genus permit an animal to communicate a desire to its owner by choosing among a variety of representative choices that are pre-programmed into a device, each choice causing the device to output a corresponding sound or message. See, for example, U.S. Pat. No. 6,722,318 B2 to Hotmer (“Animal Communication Device,” issued Apr. 20, 3004); U.S. Pat. No. 7,057,515 B2 to Smith et al. (“Pet-Activated Signaling Assembly,” issued Jun. 6, 2006). The animal's caretaker hears the noise or message output by the device and may consequently deduce the present need or desire of the animal. At least one patented device attempts to permit remote communication from owner to pet, enabling two-way telephone communication via the coupling of a speaker and microphone to a telephone, such that the owner may call said telephone from a remote location and the device will then automatically “answer” the call. The speaker and microphone are then activated so that the owner's voice is broadcast from the speaker while the microphone transmits any responsive noises made by the animal. See U.S. Pat. No. 6,910,447 B1 to Azarian (“Pet Communication Apparatus,” issued Jun. 28, 2005). This invention allows only the human party to initiate the telephone call, and it does not contemplate a means for the pet to initiate calling or dialing.

Another species of inventions in this genus permits an animal to generate activity from a toy upon triggering an actuator of said toy. U.S. Pat. No. 3,611,996 to Wegner (“Animal-Training Flyball Apparatus,” issued Oct. 12, 1971) requires a person to initially set a ball into a spring-propelled launcher which can thereafter be actuated by a dog pressing a lever. Depending on the mechanical properties of the triggering lever, this invention may not be operable by small dogs. U.S. Pat. No. 7,114,465 B1 to Winter (“Pet Operated Ball Thrower,” issued Oct. 3, 2006) claims an apparatus having a treadle pivotally attached to its base that activates a throw-arm element to throw a ball when the animal jumps on the treadle, and wherein the ball may be replaced in the throw-arm element without human assistance, permitting repetitious animal-actuation. In these examples, the animal can be considered to be expressing its own desire to play.

The concept of an electronic “watchdog” was introduced, without commercial success, in U.S. Pat. No. 4,131,887 to Birkenhead (“Intrusion Alarm system Utilizing the Barking of a Watchdog,” issued Dec. 26, 1978) which describes a system that audibly detects the urgent barking of a watchdog and issues in response an electric signal that may activate an intrusion reaction device such as an alarm, floodlights, or a remote indicator device possessed by a guardian or police agency. Unless the dog is trained to bark in response to a specific cue, and is also trained not to bark in the absence of the cue, this invention is purely passive because it does not require the dog to intentionally interact with an apparatus.

U.S. Pat. No. 7,002,466 B2 to Goehring (“Emergency Alert Systems,” issued Feb. 21, 2006) claims an emergency alert system actuatable by a either a disabled person or an assistance dog. The invention comprises a two-way radio system with a rip-cord attached to a jack receptacle in a first portable radio apparatus. The human in possession of said first radio may pull the rip cord to trigger a call activation function within said first radio that activates an alert tone in a second radio apparatus and causes the microphone of said first radio to be open for communication. Alternatively, a service dog may pull the rip-cord using its teeth, said rip cord having a loop or pendant at its distal end graspable in the animal's jaws, to achieve the same functional ends. This device is not primarily directed towards achieving reliable actuation by the dog, as illustrated by at least the following observations. First, the device is carried by the owner, making it difficult if not impossible for a dog to know where the device is located at any given moment. Second, the actuation means is a pendant that must be grasped by a dog in its mouth and then pulled a certain length, which exceeds the physical abilities of many breeds. Third, the animal-actuation means is provided exclusively in a handheld radio, limiting its practical uses.

There exists a need in the art for a third genus of active animal-actuated inventions comprising systems and methods which enable a trained animal to summon assistance to a person in need by volitionally actuating a signaling function on a stationary device that can be incorporated into mainstream electrical and electronic systems. Such a genus of invention, unlike the prior examples, entails the animal communicating on behalf of a person, as opposed to the animal communicating its own present needs or desires through the invention. Such devices implicitly demand a higher quality of manufacture and function than recreational or feeding devices because the health or safety of a person may depend upon their reliable and accurate function.

In light of the above, there exists a need in the art for versatile, reliable animal-actuated systems and devices for operating electrical loads, controlling electronic devices, and issuing signals and emergency alerts, as well as for assisting a human in operating electrical or electronic devices such as appliances, lights, and communications apparatus. These systems must be manufactured with considerable sophistication and suitably engineered to be incorporated into home electrical systems, emergency alert systems, and other mainstream modes of utility.

### Personal Emergency Alert Systems

Personal emergency alert systems facilitate the rapid response of third party assistance to individuals, locations, or property experiencing emergency conditions that require urgent or specialized attention. More particularly, personal emergency alert systems accomplish the steps of transmitting situational information from the site of an emergency to a second or third party through automated means, rather than through direct human-to-human communication. Such systems provide a mechanism to send information about a person's urgent status, or about the occurrence of an emergency situation, to a remote receiver where first responders, relatives, property owners, healthcare professionals, or other parties can become informed of that status.

When a person lives, travels, or spends periods of time alone, they may rely upon personal emergency alert systems to ensure that, in the event they become incapacitated, their condition will become promptly known to others. Property owners may apply emergency alert systems for the continuous monitoring of unattended or at-risk properties for fires, intrusions, accidents, and the like. Some basic considerations in the functionality of emergency alert systems include: what means shall be used to detect the emergency condition, what means shall be used to translate said detection into an emergency signal, how shall that emergency signal be transmitted to the responding party, what information will the emergency signal convey, to whom or where shall the emergency signal be sent, and should the system include means for confirming transmission or receipt of the signal?

A basic emergency alert systems is disclosed in U.S. Pat. No. 3,531,597 to R. J. Andrews et al. (“Telephone Reporting Set,” issued Feb. 6, 1967, “the '597 patent,” the entirety of which is incorporated by reference herein) which describes a system for surveillance of premises or equipment for the occurrence of particular preselected conditions, e.g., alarm conditions. When an alarm condition is detected, a reporting set responds by calling a supervisory station and informing the supervisory station of the source of the call and the occurrence of the condition. The specification discusses inherent challenges to the utility of such alert systems including the limited capacity to detect, differentiate, and convey specific emergency conditions through the system to the supervisory station. See, the '597 patent at col. 1, ln. 55-59 (“the monitoring capability of reporting sets has been quite limited, most sets responding to the occurrence of only a single alarm condition, or where responding to more than one condition being unable to identify which particular condition has in fact occurred”).

Another early patented form of such systems is exemplified by U.S. Pat. No. 3,662,111 to Rubinstein (“Automatic Telephone Care Device,” issued May 9, 1972, the entirety of which is incorporated by reference herein) which discloses an apparatus that attaches to a telephone line and that automatically calls for help when the user is incapacitated or otherwise unable to reach the telephone. The manner in which this system detects an emergency condition is indirect: the device is programmed to automatically generate an emergency alert call over the attached telephone at the conclusion of cyclical time periods (i.e., every few hours) unless its proximal user manually resets the device by flipping a switch. Any lapse in attentiveness or consciousness on the part of the proximal user allows the timed call to proceed and summons assistance to the address where the device is located. A later to Rubinstein, U.S. Pat. No. 3,843,841 (“Remotely Actuated Automatic Telephone Care System,” issued Oct. 22, 1974) adapts this system to incorporate a remote signaling controller that communicates by radio transmission to the calling unit of the system in order to prevent the alarm.

Such systems are inherently activated by negative feedback and they generally comprise a means for cyclically generating an alarm signal at predetermined time intervals, a switch means actuatable by a human operator for terminating said alarm, a means responsive to said alarm signal and a switch means for dialing a predetermined telephone number to transmit a prerecorded message when said switch means is not actuated within a predetermined time period after the initiation of said alarm signal. Alternatively, such a system may comprise timer means for generating a first signal at predetermined times and for generating a second signal at a predetermined time after each said first signal, a means for generating a first alarm actuating signal in response to said first signal, a means, actuatable by a human operator, for terminating said first alarm actuating signal, a means for receiving said second signal and said first alarm actuating signal for generating a second alarm actuating signal when both said signals are simultaneously received, an alarm means for providing first and second alarms perceptible to the human senses in response to said first and second alarm actuating signals, respectively, a means connectable to a telephone line and responsive to said second alarm actuating signal for dialing a predetermined telephone number and transmitting a prerecorded message upon receipt of said second alarm actuating signal, a means, actuable by a human operator, for terminating said second alarm actuating signal, and a means for successively dialing a plurality of telephone numbers and for transmitting a plurality of prerecorded messages. Such systems may incorporate remote controlling means to control each of the above elements.

A “proximal user” is one or more persons, such as an infirm patient, a handicapped individual, a household comprising an elderly couple, or anyone else at risk for being unable to summon for help to an emergency condition, who installs or uses any emergency signaling or alert system for their protection or benefit. In contrast, the “remote user” or “responding party” is any party that receives the emergency alert or signal.

Improved personal emergency alert systems incorporate direct actuation means such as panic buttons, emergency buttons, trigger switches, and the like, operable by human beings. U.S. Pat. No. 4,064,368 to Dibner (“Closed Loop Emergency Alarm and Response System,” issued Dec. 20, 1977, the entirety of which is incorporated by reference herein) claims an emergency alert system further comprising an emergency button that may be pushed by the proximal user to actuate the system and transmit an alarm signal to a remote user. This invention relates to emergency alarm systems, and more particularly to systems for monitoring and responding to the needs of elderly of infirm persons confined to residences. This invention comprises components capable of assuring the resident that his call for help has been received, and means for continued active monitoring of the residence by the remote user until help has arrived. Typical claims for such an invention are: 1. A closed-loop emergency alarm and response system comprising a first transceiver located at a residence, a compatible second transceiver at a central station, a means at the residence for activating said first transceiver to send an alarm signal to said second transceiver, a means at said second transceiver for sending a first “acknowledge” signal to the first transceiver after receipt of said alarm signal, indicating means at the residence having a “call received” made for indicating receipt of said “acknowledge” signal, a signal means at the central station for facilitating the dispatch of emergency help to the residence after the sending of said first “acknowledge” signal, a means at the residence operable by a person who has arrived at the residence in response to said dispatch from the central station to cause said residence transceiver to send an “all clear” signal to the central station transceiver, a means at the central station for causing a second acknowledgement signal to be sent to the residence transceiver after receipt of said “all clear” signal, and a means at the residence transceiver responsive to the receipt of said second “acknowledgement” signal for terminating said sending of the “all clear” signal; 2. A system according to claim 1, wherein said indicating means at the residence has an “alarm” mode activatable simultaneously with sending the alarm signal to said second transceiver, and a means responsive to receipt of said first “acknowledge” signal for discontinuing said “alarm” mode; and 3. A system according to claim 2, wherein said “call received” mode comprises a continuous “call received” signal, and a means responsive to said person-operable means for discontinuing said “call received” signal.

In addition, emergency alert systems may comprise diverse actuation mechanisms. For example, many systems entail the placement of sensors throughout a residence, the sensors being linked to regularly used appliances, traffic areas, light switches, and the like, or the sensors being motion detectors, pressure sensors, and the like, and whereby the primary user's behavior can be monitored through detection of the activation of the various sensors. The presence of distinct emergency conditions, or behaviors indicative of emergency conditions, may be deduced from the incidence or patterns of a proximal user's interaction with said sensors. See, for example, U.S. Pat. No. 3,885,235 to Bergstrom, et al. (“Resettable Timer-Alarm Device Used in Monitoring Geriatric Patients,” issued May 20, 1975, the entirety of which is incorporated by reference herein), and U.S. Pat. No. 4,259,548 to Fahey, et al. (“Apparatus for monitoring and Signaling System,” issued Mar. 31, 1981, the entirety of which is incorporated by reference herein).

Remote control capability and multiple sensors or actuators are combined in U.S. Pat. No. 4,284,849 to Anderson et al. (“Monitoring and Signaling System,” issued Aug. 18, 1981, “the '849 patent,” the entirety of which is incorporated by reference herein). This system generally comprises a monitoring and signaling system including a remote control unit in the residence of an individual, a plurality of sensors located within the residence, microprocessors to receive and process signals produced by the sensors, memory to store collected sensor data, and a centralized communication center to coordinate all. U.S. Pat. No. 4,371,751 to Hillgoss (“Automatic Telephonic User Emergency Message Transmitting Apparatus,” issued Feb. 1, 1983, the entirety of which is incorporated by reference herein) introduces programmability into personal emergency alert systems via an apparatus comprising a base station including a solid state message storage means, an alphanumeric display, and keyboard means for inputting digital data representing at least one telephone number into the data storage means and into the display for verification. The apparatus further includes input ports to receive signals from multiple indicators of alarm conditions such as sensors, burglar alarms, and fire alarms. U.S. Pat. No. 4,467,142 to Rupp et al. (“System for Transmitting Emergency Calls from Persons Requiring Assistance,” issued Aug. 21, 1984, the entirety of which is incorporated by reference herein) discloses a system having the capability of bidirectional data transmission between the calling station and the receiving station of the emergency alert. A two-way voice communication device in the emergency calling station can be switched into operation by an operating mode control signal.

Actuating sensors and switches may be statically positioned, or they may be portable. U.S. Pat. No. 4,121,160 to Cataldo (“Switch Means for Radio Alarm Device,” issued Oct. 17, 1978, the entirety of which is incorporated by reference herein) claims a wearable radio transmitter and alarm activation switch for summoning emergency services to the wearer. U.S. Pat. No. 4,510,350 to Wagner et al. (“Personal Alarm Apparatus Including Wrist Supported Transmitter and Receiver/Telephone Interface,” issued Apr. 9, 1985, the entirety of which is incorporated by reference herein) discloses a wrist mounted radio frequency transmitter including a push button trigger and a relay station connected to the telephone line. The wrist mounted element has a manually operable switch mounted on its casing and a transmitter responsive to operation of the switch for transmitting a radio frequency alarm signal, and a relay station mounted within a single housing and comprising means responsive to the alarm signal, a means for connection to a telephone line, a means for dialing telephone numbers on said line, a memory, and a means for storing in said memory a plurality of telephone numbers with an order of priority whereby said dialing means can dial each of said numbers in turn.

U.S. Pat. No. 4,760,593 to Shapiro et al. (“Personal Alarm System Providing Handsfree Operation,” issued Jul. 26, 1988, the entirety of which is incorporated by reference herein) includes a speakerphone which interfaces to a subscriber station, the subscriber station in turn interfacing over a communications link to a central monitoring station which is operative to receive and analyze messages transmitted to the central monitoring station by the subscriber station. Following transmission of a message from the subscriber station to the central monitoring station, the central monitoring station may transmit a control signal to the subscriber station which causes the subscriber station to activate the speakerphone to permit verbal communication with a subscriber who may be immobilized and/or physically unable to initiate a telephone call or answer a telephone.

Computing devices, including personal home computers, may be incorporated into personal emergency alert systems. U.S. Pat No. 5,086,391 to Chambers (“Remote Controller for Activating Speech Messages and For Contacting Emergency Services,” issued Feb. 4, 1992, the entirety of which is incorporated by reference herein) describes a medical alert system for domestic use wherein the system is comprised of two major components, a device worn about the neck and a home computer. The home computer may coordinate signaling between components of the system, control the manner and content of emergency signaling, or transmit relevant information or instructions to persons such as emergency response personnel. U.S. Pat. No. 6,456,695 B2 to Lee (“Computer Having Emergency Calling Function and Emergency Calling Method Using Computer,” issued Sep. 24, 2002, the entirety of which is incorporated by reference herein) describes an emergency call button linked to a personal computer, a graphical user interface in which a person adjusts the parameters of the system on the computer, a microprocessor for receiving the emergency detection signal from the emergency call button and restoring the computer from a powersave state or a power-off state to a normal state, and an emergency call controller for reading the emergency call message and emergency call telephone number from the memory and for making a telephone call to a designated remote third party.

Some emergency alert systems, in response to actuation, trigger multiple distinct responses. U.S. Pat. No. 5,521,582 to Kingston (“Alarm System,” issued May 28, 1996, the entirety of which is incorporated by reference herein) transmits information about an emergency condition to a remote user while simultaneously opening a voice-to-voice communication channel through a telephone line, speakerphone, radio, or other device permitting live chat between the proximal user experiencing the emergency condition and a remote user such as an emergency response service.

In addition to transmitting alarm signals comprising information about the existence and location of an emergency condition, or the identity of a person experiencing an emergency condition, advanced personal emergency alert systems may also include components that actively monitor and report patient vital statistics. For example, U.S. Pat. No. 7,238,156 to Adamczyk (“Systems, Methods, and Devices for Health Monitoring,” issued Jul. 3, 2007, the entirety of which is incorporated by reference herein) describes a health monitoring system that includes a server configured to receive a first set of information from a monitoring device, wherein the first set of information includes a health condition reading of a subscriber, and wherein said server is configured to process the first set of information and transmit a second set of information to the monitoring device and/or a telecommunications device, wherein said second set of information includes medical treatment information and/or medical advice concerning the subscriber. The health monitoring system also includes a database in communication with the server and configured to store a third set of information therein, wherein the third set of information includes emergency contact information, one or more health conditions of the subscriber, monitoring time intervals, and/or numerical ranges defining acceptable health conditions and medical alert conditions.

Emergency alert systems also include multimedia monitoring capabilities that allow a remote third party or other emergency monitoring station, upon receiving an emergency alert from a system at a particular location, to monitor conditions at said location using prepositioned cameras, communication devices, patient monitoring devices, and the like. For example, U.S. Pat. No. 6,567,502 B2 to Zellner et al. (“Multimedia Emergency Services,” issued May 20, 2003, the entirety of which is incorporated by reference herein) discloses a system and method for remotely controlling one or more monitoring devices in a user's household in the event of emergency so as to more productively monitor the emergency situation on a real-time basis. In certain embodiments, the control of such monitoring devices or the exchange of information with such monitoring devices occurs over the internet.

### Unmet Needs in the Art

Existing emergency alert systems possess certain deficiencies and drawbacks. A premise underlying the utility of these systems is that they are a relatively cost-effective means for monitoring the health and safety of proximal users, such as a solitary person, or a couple or group of individuals who are elderly, infirm, incompetent, or any person who is otherwise unsafe without supervision. The known alternative means contemplated by the prior art for monitoring the health and safety of such persons is to employ a professional caretaker or custodian who will personally supervise said persons. Employing a caretaker or custodian is not only expensive in terms of salary and other compensation paid to the caretaker, but it raises legal liability issues and introduces risk that a caretaker may abuse or neglect the persons under their care. Human beings are less trustworthy and reliable than properly programmed computerized monitors, but computers and electronic monitoring devices, in turn, are prone to malfunctions which may go undetected.

Devices in the prior art propose that “panic buttons,” or other switching devices actuatable by the proximal user of the emergency alert system, improve the reliability of such systems, but in fact these are insufficient when the proximal user becomes suddenly incapacitated. Moreover, the systems in the prior art cannot assist a person who has disabilities which preclude him or her from performing basic life functions such as turning on lights, answering the phone, operating household appliances, or using communication devices such as radios, phones and computers. An actuation means that could combine loyal service, reliable performance, broad electrical and electronic interoperability, and low costs of administration would be tremendously useful.

### SUMMARY OF THE INVENTION

The present invention addresses the needs described above. The present invention comprises devices or systems that are volitionally actuated by trained animals in response to specific or generalized cues, and which permit such trained animals to operate electrical, electronic, signaling, or emergency alert systems and devices. In preferred embodiments, the present invention comprises a device, specially adapted for actuation by canines, that integrates electrical, electronic, signaling, and/or emergency alert systems in order to operate a health monitoring and emergency alert system for humans. The present invention comprises systems incorporating the use of said animal-actuated devices to summon assistance to persons or locations experiencing emergency conditions and/or to provide assistance to humans by operating devices, appliances, and equipment necessary to perform basic life functions ranging in importance from, for example, turning on a light switch to, for example, calling a health provider over a wireless communication network. A sufficiently intelligent non-human animal, such as a canine, can be trained to actuate the electrical, electronic, signaling and emergency alert systems of the present invention in response to distinct or generalized cues.

As used throughout this specification, the term “electrical load” comprises any electrical device connected to an electrical conductor including equipment, devices or machines that use electricity to perform work. Examples of electrical loads include, but are not limited to, such things as light bulbs, clothes washers and dryers, coffee pots, ovens, computers, motors, fans, pumps, and the like. Most electrical loads are divided into categories according to their voltage utilization. Low voltage loads are typically 24-600 VAC which are the alternating current utilization voltages used in most residential, commercial and industrial buildings and equipment. 6-250 VDC are the direct current utilization voltages used in most residential, commercial and industrial buildings and equipment. Medium voltage loads are typically 600-34,500 VAC which are the alternating current utilization voltages used in most commercial and industrial buildings and for powering equipment. Transmission voltage loads are typically 34.5 kV to 750,000 VAC which are the alternating current utilization voltages used in most utility grade transmission and distribution systems throughout the world. The systems and devices of the present invention are intended to permit trained animals to interact with and control electrical loads.

The term “electronic” comprises any electrical device connected to a circuit board via control wiring or circuit board tracing that conducts low voltage signals or current through electronic components and devices such as resisters, rectifiers, computer chips, capacitors, invertors, transistors, tubes, potentiometers, relays, switching devices, amplifiers, signal generators, digital counters, power supplies, diodes, sensors, transformers, fuses or other circuit protection devices, speakers, push buttons, proximity devices, motion sensors and microphones. Electronic devices provide interface between discrete inputs and outputs operated by humans or computer processors and their associated software or firmware. The systems and devices of the present invention are intended to permit trained animals to interact with and control electronic devices.

The term “signaling” may refer to any device which generates either an analog or digital signal which then travels from the first device to another through the atmosphere or which travels via an electrical conductor, silicone sand, microwave signal, fiberoptic conductor or other transmission or communications medium or path for the purpose of transmitting or receiving information from one device to another device or person. The systems and devices of the present invention are intended to permit trained animals to interact with and control signaling devices and systems.

An emergency condition may be any event or occurrence that arises in relation to a person, place, or object. The term “emergency condition” comprises any condition in which a person or property undergoes a change in status or need, or when a person experiences a desire or requirement for assistance in some matter or task. For example, a person may experience emergency conditions such being in danger, at risk, injured or sick, in distress, in ill-health, in deprivation, in need, or under duress. Similarly, a property or location may experience emergency conditions when an event threatens its integrity or security, or when a person in proximity thereto experiences an emergency condition. A signal designating the occurrence of an emergency condition may comprise an alarm, a transmitted message, an electrical or electronic function, or any other function that conveys situational information.

The present invention permits dogs, or any other trainable animals, to serve as actuators of systems and devices that (1) mechanically, electrically, or electronically signal the occurrence of an emergency condition, and/or that (2) assist an incapacitated or otherwise incapable human in operating a mechanical, electrical, or electronic device. For example, the systems and devices of the present invention may permit a trained animal to assist a human with performing the daily activities of life by actuating electrical or electronic systems and devices. In one embodiment, an animal actuated switch in a device encompassed by the present invention may be incorporated into household electrical circuitry to perform functions on behalf of a human such as turning lights on and off, controlling electrical appliances, and issuing communications or signals about emergency conditions.

Animal actuated devices of the prior art, as described above, are inadequately compatible with personal emergency alert devices and systems, and are not constructed such that they can be safely, reliably, or even legally (depending on local ordinances) implemented. The present invention provides the requisite mechanical sensitivity, functional versatility, durability, and safety features to be suitable for use by animals in the important task of calling for assistance during an emergency condition threatening health, safety, life, or property and to provide assistance performing basic life tasks. The features of the actuation means in the present invention are adapted to be accurately and reliably operated by animals ranging from very small to very large in size. The systems incorporating the device have expandability and versatility so that multiple types of third-party individuals may be appropriately summoned by an animal in response to multiple or distinct contexts and cues, and so that multiple electrical and electronic devices may be actuated downstream of a canine-generated signal. The present invention may be modified as described herein to be compatible with pre-existing components of the various emergency alert and security systems in the prior art as well as discrete electrical and electronic devices in the prior art. The present invention resides not merely in any one of the features set forth in this specification, but also in the particular combination of all of the features and improvements claimed.

In at least one embodiment, an animal-actuated device of the present invention is operably linked to any pre-existing emergency call or security system. For example, a trained canine may be present at a residence with its owner, the owner being a person requiring health and safety monitoring (a proximal user). The canine is trained to recognize one or a plurality of emergency conditions or commands and to respond to said conditions or commands by traveling to the canine-actuated device which may be set on the floor in the proximal user's house, for example. The canine performs a trained action, such as stepping on a contact plate switch, to execute a particular function on behalf of the proximal user. The device may be directly wired into circuitry comprising electrical loads or may issue a wireless signal that activates other devices according to any means known in the art for conducting or transmitting electrical, electronic, or wireless signaling.

In at least one embodiment, an animal-actuated device of the present invention controls traditional electrical and electronic devices as light switches, telephones, computers, green technologies (such as those devices and equipment that are designed to switch off automatically when not in use and turn back on only when needed) and is actuated by a trained animal in response to a cue or command. The device of the present invention may be powered by AC current through a power cord that connects to an electrical receptacle on the device and plugs into a standard outlet in the wall. The canine actuates the device by placing a paw upon the actuation means of the device, which may be, for example, a depressable button or contact plate switch. In particular, the actuation means may comprise an American Disabilities Act (ADA) Compliant, UL and CSA Listed, 120VAC, 30 VDC rated, 15 amp, maintained or momentary contact, single pole, double throw or double pole, double throw switch capable of supporting 200 pounds and with a ¼ pound trigger weight suitable for use by canines from 5 to 250 pounds. The contact plate is comprised of stainless steel with recessed fastening screws to provide an accessible surface for the animal's paws.

In a preferred embodiment, the contact plate has beveled edges to accommodate imprecise placement of paws upon said contact plate switch, such that an indirect angle of incidence of the force applied by the animal to the plate will nevertheless achieve actuation. A bezel surrounds the base of the actuation means to prevent the animal's paws, claws, or fur from becoming pinched thereunder. Such injury to the animal would cause pain when the animal is being trained on the device and would therefore decrease the animal's positive incentives to fulfill its trained actuation tasks. The device is constructed in various sizes and configurations appropriate for each particular need, use, or placement.

When activated, the actuation means generates an electrical or electronic signal that is transmitted to a transceiver device or other electrical load or electronic device. In at least one embodiment, said signal may also be transmitted to a reporting element such as a bell, buzzer, light or ringer. This reporting element is useful for the training phase in which the animal is taught to use the device. A successful response to a designated cue, achieved when the animal correctly activates the actuation means, produces a sound from the reporting element that “congratulates” the animal for performing its duty correctly and informs the trainer of success.

A transceiver device of a preferred embodiment of the present invention comprises an off-the-shelf emergency alert transceiver unit such as the Life Call Medical Alarm System or standard electrical devices which can be mounted inside the device or provided in a separate location. The transceiver may comprise a remote or local electrical or electronic device having one or a plurality of power, control, signal, call, listening or dialup functions. Actuation of the actuation means by the animal results in transmission of the emergency alert or signal to a third party, or actuation of operation or termination of operation of the connected electrical load. Alternatively or in addition to the transceiver, the signal generated by the actuation means may be passed through a router, computer, or other relay means to transmit the emergency signal to the desired remote user/responders, security system, appliance, or building automation or control system. The system can be adapted to generate a plurality of responsive functions such as calling a predetermined phone number, issuing a wireless signal such as a cellular phone call, summoning emergency services, turning on or off an electrical load, initiating communication with a health monitoring subscriber center or providing comfort and basic needs to the human proximal user.

The forgoing summary has outlined some features consistent with the present invention in order that the following detailed description thereof may be better understood, and in order that the present contribution to the art may be better appreciated. The present invention is not limited in its application, details, or components merely to those set forth in the following description and illustrations. Devices consistent with the present invention are capable of other embodiments. Also, the phraseology and terminology employed herein are for the purpose of description and should not be regarded as limiting unless explicitly stated as such.

Those skilled in the art will appreciate that the conception upon which this disclosure is based may readily be utilized as a basis for designing of other structures, methods, and systems for carrying out the several purposes of the present invention. It is important, therefore, that the claims be regarded as including such equivalent constructions insofar as they do not depart from the spirit and scope of the devices consistent with the present invention.

### BRIEF DESCRIPTION OF THE DRAWINGS

FIG. 1A is a perspective view of a first embodiment of the animal-actuated signaling device standing on its lateral side.

FIG. 1B is a top view of a first embodiment of the animal-actuated signaling device.

FIG. 2 is bottom view of a first embodiment of the animal-actuated signaling device with a bottom panel removed to reveal inner components.

FIG. 3 is a side view of a first embodiment of the animal actuated signaling system of the present invention being actuated by a canine

### DETAILED DESCRIPTION OF THE DRAWINGS

Throughout all the Figures, same or corresponding elements are indicated by the same reference numerals.

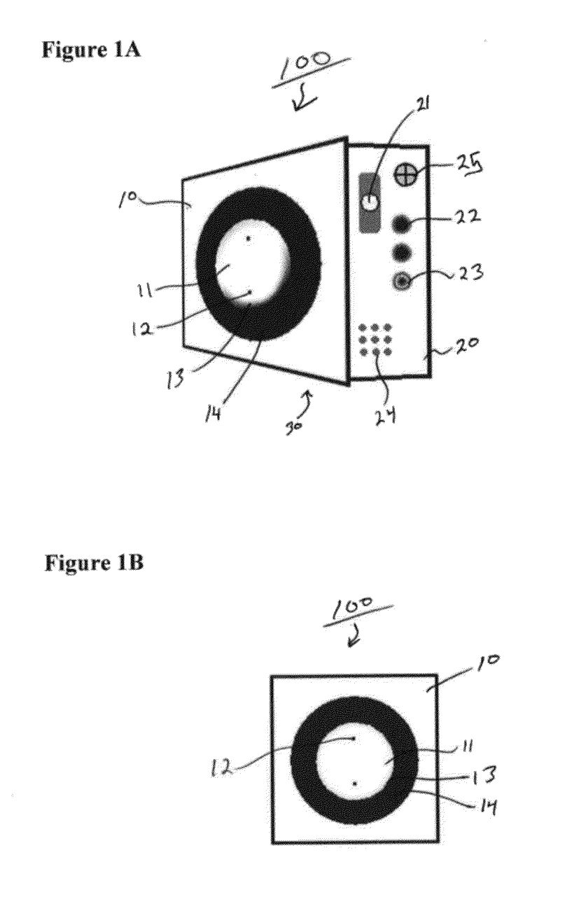

FIG. 1A is a perspective view of a first embodiment of the animal-actuated signaling device 100 resting on a lateral panel 30. The top panel 10 of the device houses an actuation means comprising a stainless steel contact plate 11 or other trigger switch. In a preferred embodiment, said actuation means 11 is an Americans with Disabilities Act (ADA) Compliant, Underwriters Laboratories (UL) and Canadian Standards Association (CSA) listed, 120 VAC, 30 V DC rated, 15 amp, maintained or momentary contact, single pole, double throw or double pole, double throw switch capable of supporting 200 pounds having a ¼ pound trigger weight suitable for use by canines from 5 to 250 pounds. Said contact plate 11 is surrounded by a bezel 14 that shields the underside of the contact plate 11 and prevents an animal's appendages from becoming entrapped or pinched beneath the contact plate 11 during actuation. Said contact plate 11 in its inactivated or resting position extends slightly above the top of the bezel 14 and features a beveled edge 13 which provides an additional surface area for contact by the actuating animal's paws. When depressed by an animal, the contact plate 11 may recede below the top of the bezel 14, and said contact plate 11 may be supported internally by springs, compressed air, or other resistance means. The top surface of said contact plate 11 is fabricated with recessed screws 12 or other fastening means for connecting said contact plate 11 to the device 100 which avoid creating protrusions on the upper surface of said contact plate 11 that may injure an animal's paws.

A side panel 20 of the signaling device 100 of FIG. 1A houses several control means and functional elements. Said control means and functional elements may be distributed throughout any surfaces of the device 100. One or more of a switch 21 may be present as an on/off power switch, as a bypass means for actuation of the emergency alert system by a human, as a system reset button, or for any other function. One or more input/output jacks 22 may be present to provide interconnectivity with power sources, communication devices, or additional devices and circuits. Any of said jacks 22 may comprise a jack for telephone or computer network connectivity, including a duplex RJ-11 and/or RJ-25 jack. A power source connector 23 may comprise a female Twist-Lock 15 A, 2-wire receptacle with Ground or NPT for rigid or flex conduit. An external power cord (not shown), such as four foot 14-3 AWG 5.0 cord with single phase, 120 V, 15 Amp, 3-prong male wall plug or rigid or flex conduit with 14-3 AWG wire, may be optionally connected to the power source connector 23. Perforations or a speaker grill 24 may be present in a lateral side panel, e.g., 20, to allow air flow between the interior and exterior of the device 100 or as an exit for sound generated by an internal reporting element such as a bell 108 or speaker. A microphone 25 may be provided for purposes such as interactive control or programming of the system.

FIG. 1B is a top view of a first embodiment of the animal-actuated signaling device 100. The device 100 is covered by a top panel 10 housing the actuation means 11. The arrangement of the bezel 14 around the perimeter of the actuation means 11 is particularly apparent in this Figure. During use of the device 100, an animal responding to an emergency condition steps atop this upper surface 10 of the device 100 and places one or more paws or other appendages on the actuation means 11. The weight or activity of the animal causes the actuation means 11 to generate an electrical or electronic signal that activates the downstream elements of the system, ultimately leading to receipt by a remote user of information describing an emergency condition or other situational information.

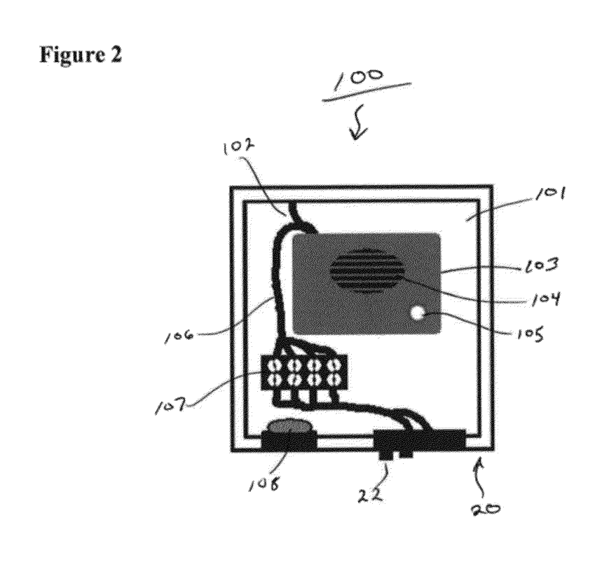

FIG. 2 is bottom view of a first embodiment of the animal-actuated signaling device 100 with a bottom panel removed to reveal internal components. Some or all of the internal components may be mounted on an internal mounting surface 101. Neoprene rubber or other resilient material may be used to seal the edges of the device or to insulate the internal components. Wires or other connection means 102 operably link the actuation means 11 to a transceiver 103, either directly or through an electrical router such as the terminal block 107. Said wires may comprise 120V single phase 14-3 AWG wire and may provide power to multiple components of the device including the trigger switch of the contact plate 11, and may be routed through the terminal block 107. The transceiver 103 may comprise an off-the-shelf emergency alert transceiver sold by third party manufacturers, such as the Life-Alert Personal Emergency Response and Home Medical Alert System, or it may be any other receiver, receiver-transmitter, and the like. In the pictured embodiment of FIG. 2, the transceiver 103 is shown having a speaker 104 and an emergency call button 105. The transceiver 103 may contain microprocessors or other signal processing means, memory or information storage means, message or voice recordation and playback means, and other electronic components characteristic of an alert system or signal transduction device.

The transceiver 103 receives information from the actuation means 11, or additionally from other sensors typical of an emergency alert or home monitoring system, and then disperses responsive signals via further electronic, electrical, or wireless transmission means 106. In the preferred embodiment of FIG. 2, said further transmission means 106 is a wire routed through a terminal block 107 that is operably linked to one or more input/output functions of the system. A first output function may comprise a reporting element 108 such as a buzzer or bell which produces a sound responsive to actuation of the device 100 by an animal. Additionally, output functions may be accomplished via components external to the device 100 through the output jack(s) 22. In place of or in addition to an output jack, the device 100 may comprise a wireless transmission means for outputting responsive signals or information. The device 100 may be powered by AC current, as through the power source connector 23, DC current from batteries, or any other suitable means for providing power to the device.

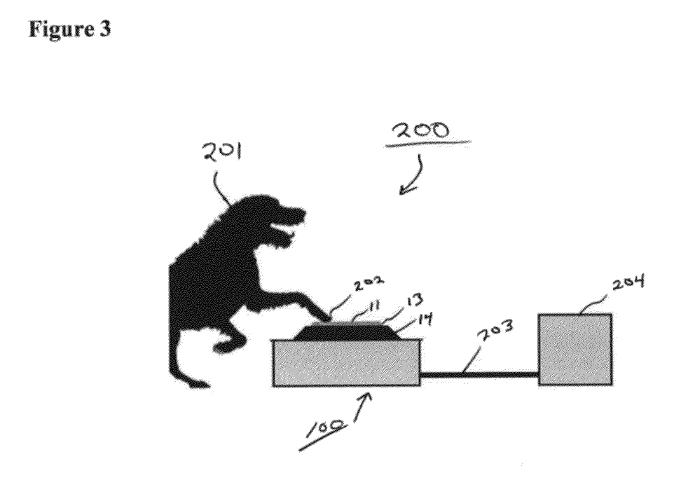

FIG. 3 is a side view of a first embodiment of the animal actuated signaling and emergency alert system 200 of the present invention in which the actuation device 100 is being actuated by a canine 201. The device 100 is positioned on the floor of a dwelling or property with the contact plate 11 facing upwards, and the device 100 is positioned in a fixed location so that the responsive animal 201 knows where to go when a conditioned cue demands his or her activation of the invention. In response to an emergency condition, the canine 201 actuates the actuation means 11 with a paw 202. The features of the actuation means, such as the beveled edge 13 and bezel 14 and recessed screws 12 are examples of adaptations that make the device 100 safe and reliable when used by animals.

A cord 203 extends to a base unit 204, or alternatively to some other electrical or electronic circuit, which may comprise means for transmitting and/or processing emergency alert signals, means for operating electrical or electronic devices, and any other means for executing functions consistent with the purposes of the present invention described throughout this specification. The base unit 204 may also comprise a personal computer or other computing means that is in two-way communication with the device 100 and that modulates input and output from the present invention. Instead of a cord 203, the connection to the base unit 204 may be achieved via a wireless communication means. Instead of a base unit 204, the system 200 may rely solely upon the transceiver 103 to communicate emergency information to remote users. The base unit 204 may further comprise a cellular or landline phone, internet router, or other communication means.

An animal may be trained to actuate the system 200 in response to specific or general cues that indicate an emergency condition, and/or that arise from a situation in which a person requires assistance in operating a mechanical, electrical, or electronic device. Such cues may include verbal commands, nonverbal commands, or observations that the animal has been trained to recognize, said observations comprising, for example, fires, intruders, the incapacity or unresponsiveness of a human, the output signal from a biometric monitoring device worn by a human, some harm or risk presently affecting to a human, some damage to property, and the like. Various embodiments of the present invention may eliminate the emergency signaling function altogether and may instead solely transmit information that controls other electrical or electronic systems. These applications may be useful for assisting humans in operating household appliances or light switches, for example.

The device 100 may be constructed in various sizes and configurations appropriate for each particular need, use, or placement. A first dimension of the device 100, Dimension A, is the length of a side of the top panel 10. A second dimension of the device 100, Dimension B, is the height of the device 100 as determined by the length of a side of panel 20. A third dimension of the device 100, Dimension C, is the length of a side of panel 20 substantially perpendicular to that measured for Dimension B. A fourth dimension of the device 100, Dimension D, is the diameter of the actuation means 11. Table T1, “Dimension Information,” provides sample relationships between dimensions for different embodiments and switch types of the present invention.

It should be emphasized that the above described embodiments of the present invention exemplify some, but not all, possible implementations of the present invention and have been set forth in order to provide a clear understanding of its qualities. Variations and modifications may be made to the above-described embodiments of the devices and systems of the present invention without departing from the spirit and principles of the invention. All such modifications and variations are intended to be included herein.

TABLE T1
Dimension Information.

| | A Di- | B Di- | C Di- | D Di- | Switch |
|---|---|---|---|---|---|
| | mension | mension | mension | mension | Type |
| Switch | | | | | |
| System | | | | | |
| Model No | | | | | |
| CD-601- | 36″ | 36″ | 6″ | 6″ | SPDT |
| SPDT(36) | | | | | |
| CD-601- | 36″ | 36″ | 6″ | 6″ | DPDT |
| DPDT(36) | | | | | |
| CD-601- | 24″ | 24″ | 6″ | 6″ | SPDT |
| SPDT(24) | | | | | |
| CD-601- | 24″ | 24″ | 6″ | 6″ | DPDT |
| DPDT(24) | | | | | |
| CD-601- | 12″ | 12″ | 6″ | 6″ | SPDT |
| SPDT(l2) | | | | | |
| CD-601- | 12″ | 12″ | 6″ | 6″ | DPDT |
| DPDT(l2) | | | | | |
| CD-401- | 4″ | 4″ | 4″ | 4½″ | SPDT |
| SPDT(4) | | | | | |
| CD-401- | 4″ | 4″ | 4″ | 4½″ | DPDT |
| DPDT(4) | | | | | |
| CD-401- | 4″ | 2″ | 4″ | 4½″ | SPDT |
| SPDT(2) | | | | | |
| CD-401- | 4″ | 2″ | 4″ | 4½″ | DPDT |
| DPDT(2) | | | | | |
| Switch | | | | | |
| Accessory | | | | | |
| Model No. | | | | | |
| CD-201- | 4″ | 2″ | 2″ | n/a | Box |
| ACC(S) | | | | | extender |
| CD-401- | 4″ | 4″ | 2″ | n/a | Box |
| ACC(D) | | | | | Extender |
| CD-½- | 4″ | ½″ | | | Conduit |
| ACD(C) | | | | | Extender with |
| | | | | | ½″ NPT |
| CD-¾- | 4″ | ¾″ | | | Conduit |
| ACD(C) | | | | | Extender with |
| | | | | | ¾″ NPT |

What is claimed is:

1. An animal-actuated signal-transduction system comprising
a switch mounted on a container,
said switch comprising a depressable platform operably linked to a means for controlling at least one electrical circuit wholly or partially enclosed within said container,
said depressable platform having an upper surface facing away from the container, an underside facing towards the container, and lateral edges,
wherein said depressable platform has a trigger weight of approximately one fourth of a pound and can support up to approximately 200 pounds, and wherein said switch is activated when an animal depresses the platform using a paw, hoof, or other limb,
a bezel, said bezel fitting closely around the periphery of the depressable platform and said bezel being fixedly attached to the container, such that said bezel prevents the animal from contacting the lateral edges and underside of the depressable platform, thus guiding the animal to contact the depressable platform only on its upper surface,
said at least one electrical circuit comprising one or a plurality of an electrical load in the form of any electrical, mechanical, or electronic device, such that activation of the switch by the animal is transduced by the circuit into at least one responsive function from said electrical load.

2. The animal-actuated signal-transduction system of claim 1 wherein the at least one electrical circuit comprises a personal emergency alert system.

3. The animal-actuated signal-transduction system of claim 1 wherein the at least one electrical circuit comprises one or a plurality of any of an alarm, bell, buzzer, siren, loudspeaker, or other reporting device.

4. The animal-actuated signal-transduction system of claim 1 wherein the at least one electrical circuit comprises a household appliance.

5. The animal-actuated signal-transduction system of claim 1 wherein the at least one electrical circuit comprises a light.

6. The animal-actuated signal-transduction system of claim 1 wherein the at least one electrical circuit comprises a means for wireless transmission of information to one or a plurality of remote wireless receivers.

7. The animal-actuated signal-transduction system of claim 1 wherein the at least one electrical circuit comprises an electronic circuit.

8. The animal-actuated signal-transduction system of claim 1 wherein the at least one electrical circuit comprises an electronic computer system.

9. The animal-actuated signal-transduction system of claim 1 wherein the at least one electrical circuit comprises a telecommunications device.

10. The animal-actuated signal-transduction system of claim 1 wherein the at least one electrical circuit comprises a means for controlling access through a door, window, or other passageway.

11. The animal-actuated signal-transduction system of claim 1 wherein the at least one electrical circuit comprises a means for locking and unlocking a lock.

12. The animal-actuated signal-transduction system of claim 1 wherein the animal is a canine

13. The animal-actuated signal-transduction system of claim 1 wherein the switch comprises a contact plate and an American Disabilities Act-Compliant, UL and CSA Listed, 120 Volt AC, 30 Volt DC rated, 15 amp, maintained or momentary contact, single pole double throw or double pole double throw switch.

14. The animal-actuated signal-transduction system of claim 13 wherein the contact plate is constructed substantially of stainless steel and has recessed fastening screws.

15. The animal-actuated signal-transduction system of claims 1 further comprising a power source connector to supply alternating or direct current to the at least one electrical circuit.

16. The animal-actuated signal-transduction system of claim 15 wherein the power source connector comprises a female Twist-Lock 15 Amp, 2-wire receptacle with Ground or NPT for rigid or flex conduit.

17. The animal-actuated signal transduction system of claim 15 wherein the power source connector comprises an external power cord for plugging into a power outlet or wall jack.

18. The animal actuated signal transduction system of claim 17 wherein the external power cord is a 14-3 AWG 5.0 cord with single phase, 120V, 15 A, 3-prong male wall plug or rigid or flex conduit with 14-3 AWG wire.

19. The animal actuated signal-transduction system of claim 1 wherein the container further comprises one or a plurality of any of buttons, dials, switches, circuitboards, and other control means for activating, adjusting, programming, adjusting and otherwise controlling the at least one responsive function from said electrical load.

20. A method for enabling an animal to summon assistance to a human in response to an emergency condition, the method comprising the steps of:
Training an animal to recognize an emergency condition of a human;
training said animal to react to the emergency condition by placing at least one paw, hoof, or other limb upon a switch, wherein said switch is a depressable platform operably linked to a means for controlling at least one electrical circuit, said at least one electrical circuit comprising a means for communicating the existence of the emergency condition to one or a plurality of remote third-parties,
installing the switch in an area occupied or owned by a human and inhabited by the animal so that the switch is accessible to the animal when the emergency condition occurs and so that activation of the switch by the animal operates the means for communicating the existence of the emergency condition to said remote third-parties.

21. A method for enabling an animal to operate electrical and electronic devices on behalf of a human, the method comprising the steps of:
said at least one electrical circuit comprising one or a plurality of an electrical load in the form of any electrical, mechanical, or electronic device, such that activation of the switch by the animal is transduced by the electrical circuit into at least one responsive function from said electrical load,
connecting a switch to an electrical circuit, said switch comprising a depressable platform operably linked to the circuit and said circuit comprising one or a plurality of an electrical load in the form of any electrical, mechanical, or electronic device, such that activation of the switch by the animal is transduced by the circuit into at least one responsive function from said electrical load,
training an animal to depress the switch in response to a command issued by a human or in response to a conditional event arising from the environment,
installing the switch in an area occupied or owned by a human and inhabited by the animal so that the switch is accessible to the animal when the human issues the command or when the conditional event occurs and so that activation of the switch by the animal operates said electrical or electronic devices.
